(19) United States
(12) Patent Application Publication
(10) Pub. No.: US 2008/0267306 A1
(43) Pub. Date: Oct. 30, 2008

(54) Systems and Methods for Low-Complexity Maximum-Likelihood MIMO Detection

(75) Inventors: Anuj BATRA, Dallas, TX (US); Deric W. WATERS, Dallas, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/101,767

(22) Filed: Apr. 11, 2008

Related U.S. Application Data
(60) Provisional application No. 60/914,429, filed on Apr. 27, 2007.

(51) Int. Cl. H04L 27/06

(52) U.S. Cl. 375/262

(57) ABSTRACT

Embodiments provide novel systems and methods for low-complexity maximum-likelihood detection, for use in various communication systems, e.g., multiple-input multiple-output (MIMO) systems, etc. These systems and methods enable computation of a detector that is more accurate than the max-log approximation. Embodiments comprise systems and methods for computing, using a maximum-likelihood detector, a set of log-likelihood ratio (LLR) values for a cost function of a channel input by implementing at least one accumulate LLR functional definition.

### CROSS-REFERENCE TO RELATED APPLICATIONS

The present application claims priority to U.S. provisional patent application Ser. No. 60/914,429, filed Apr. 27, 2007 and entitled “Low-Complexity Maximum-Likelihood MIMO Detector”, hereby incorporated herein by reference.

### BACKGROUND

As consumer demand for high data rate applications, such as streaming video, expands, technology providers are forced to adopt new technologies to provide the necessary bandwidth. Multiple-Input Multiple-Output (“MIMO”) is an advanced radio system that employs multiple transmit antennas and multiple receive antennas to simultaneously transmit multiple parallel data streams. Relative to previous wireless technologies, MIMO enables substantial gains in both system capacity and transmission reliability without requiring an increase in frequency resources.

MIMO systems exploit differences in the paths between transmit and receive antennas to increase data throughput and diversity. As the number of transmit and receive antennas is increased, the capacity of a MIMO channel increases linearly, and the probability of all sub-channels between the transmitter and receiver simultaneously fading decreases exponentially. As might be expected, however, there is a price associated with realization of these benefits. Recovery of transmitted information in a MIMO system becomes increasingly complex with the addition of transmit antennas. This becomes particularly true in MIMO orthogonal frequency-division multiplexing (OFDM) systems. Such systems employ a digital multi-carrier modulation scheme using numerous orthogonal sub-carriers.

Many multiple-input multiple-output (MIMO) detection algorithms have been previously proposed in the literature. The optimal algorithm is conceptually simple, but is often impractical due to the fact that its complexity increases exponentially with the number of channel inputs and alphabet size. As a result, many algorithms have been proposed to solve the problem with less complexity, with the unfortunate effect of also significantly sacrificing performance.

Many MIMO detectors have been proposed and implemented as exclusively hard detectors that only give the final estimate of the channel input. Most notable is the sphere decoding detector because it can achieve Max-Log performance in an uncoded system with much less complexity on average. A summary of many MIMO detectors may be found in D. W. Waters, “Signal Detection Strategies and Algorithms for multiple-Input Multiple-Output Channels”, Georgia Institute of Technology, PhD dissertation, December 2005, including many variations of the sphere detector that minimize complexity without sacrificing performance. At least one list-sphere detector computes the log-likelihood ratio (LLR) for a channel input. Unfortunately, implementing a list-sphere detector is still quite complex, requiring significant processing resources.

Improvements are desired to achieve a favorable performance-complexity trade-off compared to existing MIMO detectors.

### BRIEF DESCRIPTION OF THE DRAWINGS

For a detailed description of exemplary embodiments of the invention, reference will be made to the accompanying drawings in which:

FIG. 1 illustrates a block diagram of an exemplary communication system comprising an exemplary MIMO detector;

FIG. 2 is a block diagram of an exemplary MIMO detector, according to embodiments;

FIG. 3 illustrates an exemplary accumulate log-likelihood ratio (LLR) numerator and LLR denominator functional definition, according to embodiments;

FIG. 4 illustrates an exemplary accumulate LLR functional definition for implementing embodiments of a max-log detector;

FIG. 5 illustrates an exemplary accumulate LLR functional definition for computing true LLR using a recursive structure, according to embodiments;

FIG. 6 illustrates an exemplary accumulate LLR functional definition for computing true LLR using a tree structure with an even number of inputs, according to embodiments;

FIG. 7 illustrates an exemplary accumulate LLR functional definition for computing true LLR using a tree structure with an odd number of inputs, according to embodiments;

FIG. 8 illustrates an exemplary accumulate LLR functional definition for computing the LLR using the two smallest costs, according to embodiments; and

FIG. 9 illustrates an exemplary max-log detector according to embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more hardware and/or software components, and may be used to refer to an electronic device or devices or a sub-system thereof. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

It should be understood at the outset that although exemplary implementations of embodiments of the disclosure are illustrated below, embodiments may be implemented using any number of techniques, whether currently known or in existence. This disclosure should in no way be limited to the exemplary implementations, drawings, and techniques illustrated below, including the exemplary design and implementation illustrated and described herein, but may be modified within the scope of the appended claims along with their full scope of equivalents.

In light of the foregoing background, embodiments enable improved multiple-input multiple-output (MIMO) detection by providing improved maximum-likelihood detection with low complexity. Embodiments provide novel systems and methods for maximum-likelihood multiple-input multiple-output (MIMO) detection. These systems and methods enable computation of a maximum-likelihood detector that is more accurate than the max-log approximation. Embodiments are a maximum-likelihood, max-log or near-maximum likelihood detector which may be applied to a wide variety of MIMO channels including the MIMO channels created by a special precoding used in the WiMedia Alliance physical layer for the ultra wideband (UWB) system.

Although embodiments will be described for the sake of simplicity with respect to wireless communication systems, it should be appreciated that embodiments are not so limited, and can be employed in a variety of communication systems.

To better understand embodiments of this disclosure, it should be appreciated that the MIMO detection problem—namely, to recover the channel inputs given the channel outputs when there are multiple inputs and outputs—can be described using a narrowband channel model as:

\tilde{r}=\tilde{H}\tilde{s}+\tilde{w} (1)

where \tilde{H} is an M×N matrix, \tilde{s}=[\tilde{s}₁ \tilde{s}₂ . . . \tilde{s}_{N}]^{T} is an N dimensional vector of symbols that may be drawn from different alphabets, and \tilde{w} is additive noise. The narrowband channel model can be applied to broadband channels when orthogonal frequency division multiplexing (OFDM) is used. In the OFDM case, each subcarrier is modeled according equation (1). Thus, embodiments disclosed herein can easily be extended to apply to broadband channels.

Because each of the channel outputs simultaneously arrive at the receiver, and each of the channel inputs simultaneously enter the channel, the receiver can select the row- and column-ordering of the channel. Equation (2) is equation (1) rewritten making explicit the choice of row- and column-ordering of the channel matrix:

$$\begin{matrix}\begin{matrix}r = Θ ( \tilde{H} Π ) ( {Π}^{- 1} \tilde{s} ) + w \\ = Hs + w\end{matrix} & ( 2 )\end{matrix}$$

where H=Θ\tilde{H}π is an M×N matrix, Θ is an M×M permutation matrix, π is an N×N permutation matrix, and s=[s₁ s₂ . . . s_{N}]^{T} is an N-dimensional vector of symbols that may be drawn from different alphabets. It should be understood that a permutation matrix contains all zeros except for a single element in each row and column that contains a value of one.

The constellation for the the i-th symbol is defined as sᵢ ε Aᵢ. Within this constellation can be defined two other sets, A_{i,R} and A_{i,I}, where A_{i,R} is the set of unique real elements in Aᵢ, and A_{i,I} is the set of unique imaginary elements in Aᵢ. For example, if Aᵢ is a 4ⁿ-QAM constellation, then A_{i,R} and A_{i,I} would each be a 2ⁿ-PAM constellation. As another example, if n=2 then Aᵢ is a 16-quadrature amplitude modulation (QAM) constellation, and A_{i,R} and A_{i,I} are each 4-pulse amplitude modulation (PAM) constellations. Other common alphabets, by example and not by way of limitation, such as 4-QAM, 16-QAM, 64-QAM, and 256-QAM, correspond to n=1, 2, 3, and 4, respectively. Another common alphabet is binary phase shift keying (BPSK), which has only real components. The set of all valid values of sᵢ whose j-th bit have the value k is denoted Aᵢ(k,j). Similarly, A_{i,R}(k,j) is the set of all valid values of the real part of sᵢ whose j-th bit have the value k. The set containing all valid values of the channel input vector is denoted as S; another way of stating this is sεS. The set of all possible channel input vectors that have the value k in the j-th bit of the i-th element is denoted as s^{(k)}εS(k,i,j).

The output of a maximum-likelihood detector is the log-likelihood ratio (LLR) of each bit transmitted in the vectors. The LLR value indicates the probability that a given bit was transmitted as a one or zero. The maximum-likelihood detector output (LLR) for the j-th bit of the i-th symbol is defined as:

$${λ}_{i , j} = ln \frac{Pr ⌊ {b}_{i , j} = 1 \vert r ⌋}{Pr [ {b}_{i , j} = 0 \vert r ]} \qquad ( 3 )$$

where b_{i,j} is the j-th bit value as mapped from the channel input sᵢ. Using Bayes' Theorem, the equation for the LLRs can be re-written as:

$$\begin{matrix}\begin{matrix}{λ}_{i , j} = ln \frac{Pr [ r \vert {b}_{i , j} = 1 ]}{Pr [ r \vert {b}_{i , j} = 0 ]} \\ = ln \frac{{\sum }_{\hat{s} ∈ S ( 1 , i , j )} Pr [ r \vert \hat{s} = s ]}{{\sum }_{\hat{s} ∈ S ( 0 , i , j )} Pr [ r \vert \hat{s} = s ]} \\ = ln {\sum }_{\hat{s} ∈ S ( 1 , i , j )} Pr [ r \vert \hat{s} = s ] - ln {\sum }_{\hat{s} ∈ S ( 0 , i , j )} Pr [ r \vert \hat{s} = s ]\end{matrix} & ( 4 )\end{matrix}$$

When the noise is Gaussian, the conditional probability Pr[r|ŝ=s] can be expressed as follows B. Hochwald, S. ten Brink, “Achieving Near-Capacity on a Multiple-Antenna Channel,” IEEE Transactions on Communications, vol 51, no. 3, March 2003:

$$Pr [ r \vert \hat{s} = s ] = \frac{1}{{( 2 {πσ}^{2} )}^{M}} exp [ - {( r - H \hat{s} )}^{*} {( E [ {ww}^{*} ] )}^{- 1} ( r - H \hat{s} ) ] \qquad ( 5 )$$

where E[•] denotes the expectation function. The cost of the vector is defined as:

C(ŝ)=(r−Hŝ)*(E[ww*])¹(r−Hŝ) (6)

Using this cost function, the LLR can be written as:

$$\begin{matrix}\begin{matrix}{λ}_{i , j} = ln {\sum }_{\hat{s} ∈ S ( 1 , i , j )} exp [ - C ( \hat{s} ) ] - ln {\sum }_{\hat{s} ∈ S ( 0 , i , j )} exp [ - C ( \hat{s} ) ] \\ = {λ}_{i , j}^{( 1 )} - {λ}_{i , j}^{( 0 )}\end{matrix} & ( 7 )\end{matrix}$$

Computing the LLR values involves computing two similar terms λ_{i,j}⁽¹⁾and λ_{i,j}⁽⁰⁾ defined as:

$${λ}_{i , j}^{( k )} = ln ( {\sum }_{\hat{s} ∈ S ( k , i , j )} exp [ - C ( \hat{s} ) ] ) \qquad ( 8 )$$

where k ε {0,1}.

To reduce complexity, a maximum-likelihood detector may be approximated using the Max-Log approximation. The Max-Log approximation approximates λ_{i,j}^{(k)} from equation (8) by neglecting all but the maximum summand in the summation of equation (8). As a result, the Max-Log approximation of equation (8) is:

$$\begin{matrix}\begin{matrix}{\tilde{λ}}_{i , j}^{( k )} = {max}_{\hat{s} ∈ S ( k , i , j )} - C ( \hat{s} ) \\ = - {min}_{\hat{s} ∈ S ( k , i , j )} C ( \hat{s} ) .\end{matrix} & ( 9 )\end{matrix}$$

Equation (9) is clearly an approximation because in practice |S(k,i,j)|>1. It has been found that the Max-Log approximation of a Max-Log detector is often sufficiently accurate to achieve near-optimal performance because the value of exp[−C(ŝ)] decreases quickly as C(ŝ) increases. However, when a receiver is not enabled to sacrifice any performance, the Max-Log approximation of a maximum-likelihood detector is inappropriate.

The cost for a two-input channel can be written in the following form:

C(ŝ₁,ŝ₂)=α(ŝ₁)+C_{R}(ŝ₁,ŝ_{2,R})+C_{I}(ŝ₁,ŝ_{2,I}) (10)

where ŝᵢ=ŝ_{i,R}+j·ŝ,I, and α(ŝ₁) is independent of ŝ₂; . U.S. patent application Ser. No. 12/062,347, for “Low-Complexity Max-Log MIMO Detector,” hereby incorporated by reference herein, describes different ways to compute α(ŝ₁), C_{R}(ŝ₁,ŝ_{2,R}), and C_{I}(ŝ₁,ŝ_{2,I}) for different kinds of MIMO channels as well as a low-complexity method for implementing a max-log detector using equation (10) was disclosed. Namely, the max-log detector is implemented by enumerating possibilities of ŝ₁ and approximating the LLRs according to:

$${λ}_{i , j} ≅ \{ \begin{matrix}\begin{matrix}{min}_{{\hat{s}}_{1} ∈ {A}_{1} ( 0 , j ) , {\hat{s}}_{2} ∈ {A}_{2}} C ( {\hat{s}}_{1} , {\hat{s}}_{2} ) - \\ {min}_{{\hat{s}}_{1} ∈ {A}_{1} ( 1 , j ) , {\hat{s}}_{2} ∈ {A}_{2}} C ( {\hat{s}}_{1} , {\hat{s}}_{2} )\end{matrix} & if i = 1 \\ \begin{matrix}{min}_{{\hat{s}}_{1} ∈ {A}_{1} , {\hat{s}}_{2} ∈ {A}_{2} ( 0 , j )} C ( {\hat{s}}_{1} , {\hat{s}}_{2} ) - \\ {min}_{{\hat{s}}_{1} ∈ {A}_{1} , {\hat{s}}_{2} ∈ {A}_{2} ( 1 , j )} C ( {\hat{s}}_{1} , {\hat{s}}_{2} )\end{matrix} & if i = 2.\end{matrix} \qquad ( 11 )$$

With this in mind, some exemplary MIMO detector embodiments compute the costs of multiple candidates for the channel input. Using the bit mapping of each of the channel-input candidates, and their costs, such type of MIMO detector computes the LLR values of each bit. Other exemplary MIMO detector may instead compute a set of costs associated with a specific value of a specific bit. Yet other exemplary MIMO detector embodiments may use either of these two techniques for one or more selected different bits of the channel input.

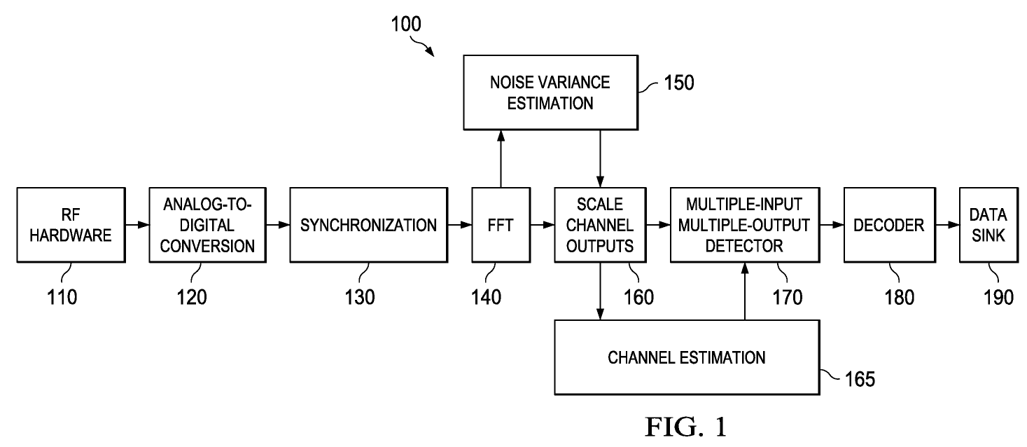

FIG. 1 is a block diagram of an exemplary communication system comprising a MIMO detector. Specifically, a wireless (e.g., radio frequency) stream of information is received at RF hardware 110, converted to a digital stream at analog-to-digital converter 120, and synchronized at 130. At this point the start of the packet has been located, and the digital stream is passed through a fast-Fourier transformation at FFT 140. The output of FFT 140 is provided to estimator 150 which estimates the noise variance of the stream. The outputs of FFT 140 and estimator 150 are provided to scaler 160 where the channel stream is preferably scaled using the noise variance estimation on the transformed stream, and separated into components. For an example, and not by way of limitation, of a scaler 160, reference is made to U.S. patent application Ser. No. 11/928,050, for “Scaling to Reduce Wireless Signal Detection Complexity”, hereby incorporated in its entirety herein by reference. The outputs of scaler 160 are preferably fed to channel estimator 165 which estimates the H matrix. Scaler 160 forwards channel output, r, and channel estimator 165 forwards the estimated H matrix to MIMO detector 170. MIMO detector 170, generates LLR values which are in turn provided to decoder 180 for analysis and/or further processing. The output of decoder 180 is stored in data sink 190 which can be any form of memory now known or later developed. This MIMO detector could also be applied to an OFDM system, where each tone has a channel output, r, and a matrix channel estimate H.

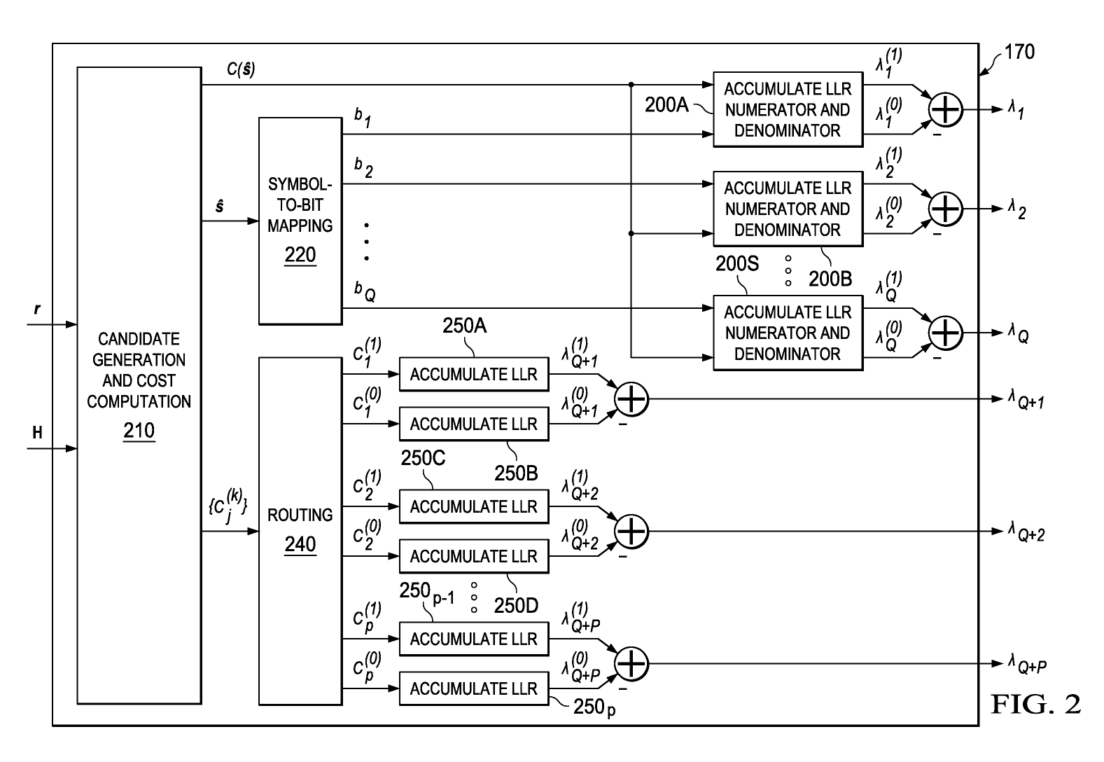

FIG. 2 shows a block diagram of an exemplary maximum-likelihood, max-log or near-maximum likelihood MIMO detector, according to embodiments. LLR values of the first Q bits of the channel input are computed from the cost of each of the channel-input candidates. The LLR values for the P remaining bits are computed using a set of costs associated with specific values of specific bits, i.e.,

$$Q + P = {\sum }_{m = 1}^{N} \vert {A}_{m} \vert$$

is the total number of bits in the channel input. It is expressly understood that Q=0 or P=0 is possible. For convenience the following notation will be used; specifically, the LLR from equation (7) is denoted as:

$${λ}_{n} = {λ}_{i , j} , \\ where \\ n = j + {\sum }_{m = 1}^{i - 1} \vert {A}_{m} \vert \qquad ( 12 )$$

Likewise, the two terms on the right-hand side of equation (7) are denoted in FIG. 2 as:

$${λ}_{n}^{( k )} = {λ}_{i , j}^{( k )} \qquad ( 13 )$$

It should be understood that in FIG. 2, C(ŝ) is the cost associated with the channel-input candidate ŝ, bₙ is the value of the n-th bit from the bit mapping of ŝ, and Cⱼ^{(k)} is the cost associated with the (S+j)-th bit of the channel input having the value k. Candidate generator and cost computer 210 provides each cost C(ŝ) to Accumulate LLR Numerator & Denominator(s) 200 (e.g., 200_{A}, 200_{B}, . . . 200_{S}) and the bits of each channel-input candidate ŝ, via symbol-to-bit mapper 220, to Accumulate LLR Numerator & Denominator(s) 200. Candidate generator and cost computer 210 further provides the set of costs {Cⱼ^{(k)}} to router 240 to pair-wise separate and forward to Accumulate LLR 250 (e.g., 250_{A}, 250_{B}, 250_{P}).

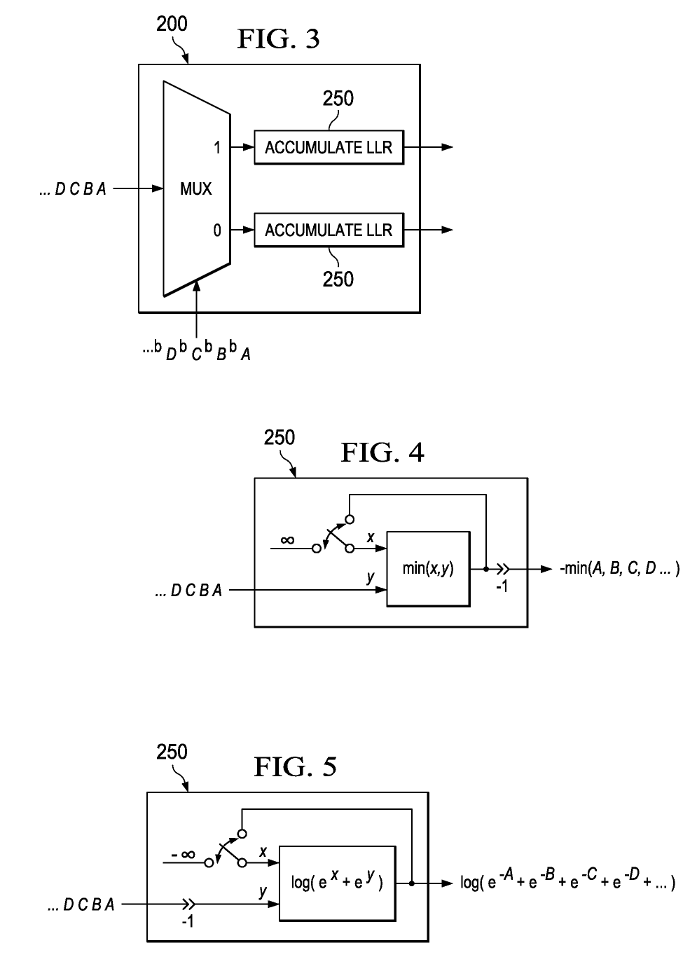

There are two types of LLR accumulators illustrated in the exemplary embodiment of FIG. 2; the first type is denoted “Accumulate LLR” 250 and the second type is denoted “Accumulate LLR Numerator & Denominator” 200. FIG. 3 shows an exemplary “Accumulate LLR Numerator & LLR Denominator” functional block 200 in more detail, where “ . . . D C B A” represents costs being sequentially input, and “ . . . b_{D} b_{C} b_{B} b_{A} ” represents the bit values associated with each of the input costs. LLR Numerator & Denominator accumulator 200 is a combination of two “Accumulate LLR” functional blocks 310 and 320. It should be observed at this point that functional blocks may be implemented in software, hardware or a combination of both. Each LLR accumulator 250 is designed to compute either λ_{i,j}⁽¹⁾ or λ_{i,j}⁽⁰⁾ from equation (7), while the LLR Numerator & Denominator accumulator 200 is designed to compute both λ_{i,j}⁽¹⁾ and λ_{i,j}⁽⁰⁾ from equation (7). The specific implementation of LLR accumulator 250 should be selected to satisfy a communication system's performance and complexity constraints. For example, if an LLR accumulator 250 uses the recursive structure with a minimization as shown in FIG. 4, MIMO detector 170 employs the max-log approximation as it computes LLR values. Alternatively, performance can be improved by using one of the other LLR accumulator 250 embodiments shown in FIGS. 5-8. Moreover, it is expressly understood that three further alternative embodiments are possible by replacing log(exp[x] +exp[y]) with max(x, y) in the exemplary embodiments illustrated in FIGS. 5, 6 and 7.

FIG. 4 illustrates an exemplary accumulate LLR functional definition for implementing embodiments of a max-log detector. Such detector tracks the minimum cost for each possibility of each bit input, and inherently employs the max-log approximation discussed above. The serial and sequential inputs “ . . . D C B A” represent costs for a given value of a given bit. It should be appreciated that although the serial and sequential inputs are referred to as “ . . . D C B A”, it could be alternatively referred to, and understood, as “ . . . A B C D”, “ . . . A D C B”, or any other order—so long as the inputs are serial and sequential.

FIG. 5 illustrates an exemplary accumulate LLR functional definition for computing the true or exact LLR using a recursive structure for implementing embodiments of a maximum-likelihood MIMO detector. As noted above, the serial and sequential inputs “ . . . D C B A” represent costs for a given value of a given bit. In the exemplary embodiment of FIG. 5, when A is input (y=A), the second input of the log(exp[x]+exp[y]) block is set such that exp[x]=0, ideally x=−∞. When B is input (y=B), the switch has closed such that A and B are input into the true LLR computation block log(exp[x]+exp[y]), when C is input (y=C), the second input into the true LLR computation block is x=log(exp[A]+exp[B]), and so forth. This process continues until all the costs for the given value of the given bit are processed.

As noted previously, other embodiments may alternatively employ the recursive structure of the exemplary embodiment of FIG. 5 but replace log(exp[x]+exp[y]) with max(x, y). Such embodiments effectively achieve an equivalent implementation to the exemplary embodiment illustrated in FIG. 4. It expressly understood that a recursive structure could be expanded and implemented in any number of ways, including a fully parallel approach or a combination of recursion plus parallel approach.

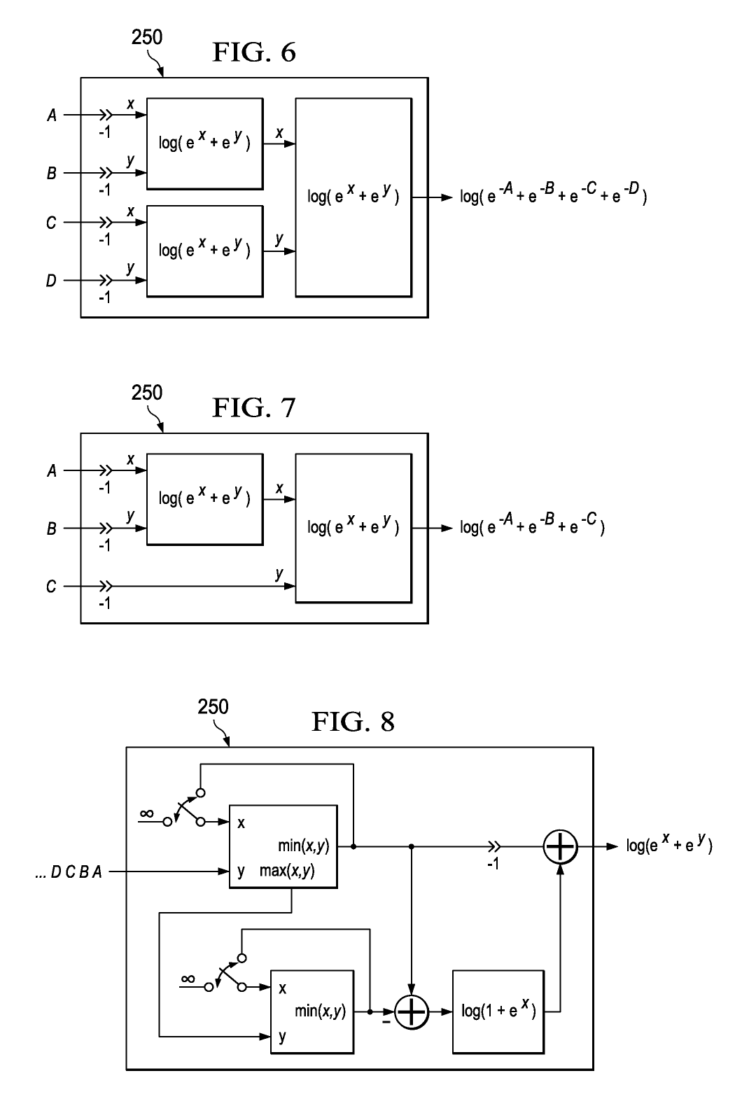

When an even number of costs are simultaneously available, then the true LLR may be computed in parallel fashion using a tree structure. FIGS. 6 and 7 illustrate exemplary accumulate LLR functional definitions for computing true LLR using a tree structure with an even number of inputs (FIG. 6) or an odd number of inputs (FIG. 7), respectively. Using a combination of these two functional blocks, the true LLR for I inputs may be computed using I-1 LLR computations log(exp[x]+exp[y]).

As noted previously, other embodiments may alternatively employ the tree structure of the exemplary embodiment of FIGS. 6 and 7 but replace log(exp[x]+exp[y]) with max(x, y). Such embodiments effectively achieve an equivalent implementation to the exemplary embodiment illustrated in FIG. 4.

FIG. 8 illustrates an exemplary accumulate LLR functional definition for computing the LLR using the two smallest (i.e., most minimum) costs, according to embodiments. If the two smallest costs for each value of each given bit are computed and used to compute the LLR, the resulting detector is the maximum-likelihood detector if either binary phase-shift keying (BPSK) or four-point quadrature amplitude modulation (4-QAM) is used. For other alphabets, the resulting approximation is more accurate than the max-log approximation. The exemplary embodiment of FIG. 8 keeps track of the two smallest costs. As before, the inputs “ . . . D C B A” represent costs for a given value of a given bit being sequentially inputted. When A is input (y=A), the second input of the min-max block is set such that exp[x]=0, ideally x=−∞. When B is input (y=B), the second input of the min-max block is x=A. The minimum of A and B is fed back to be compared with the next input C; meanwhile, the maximum of A and B is passed as the y-input of the minimum (min) computational block. After all inputs have been processed, the output of the min-max computation block is the minimum of all the inputs, and the output of the min computational block is the second smallest of all the inputs. This architecture may be extended to keep track of the K smallest costs, by cascading multiple min-max computational blocks, and passing the outputs into a separate LLR accumulator computational block 250.

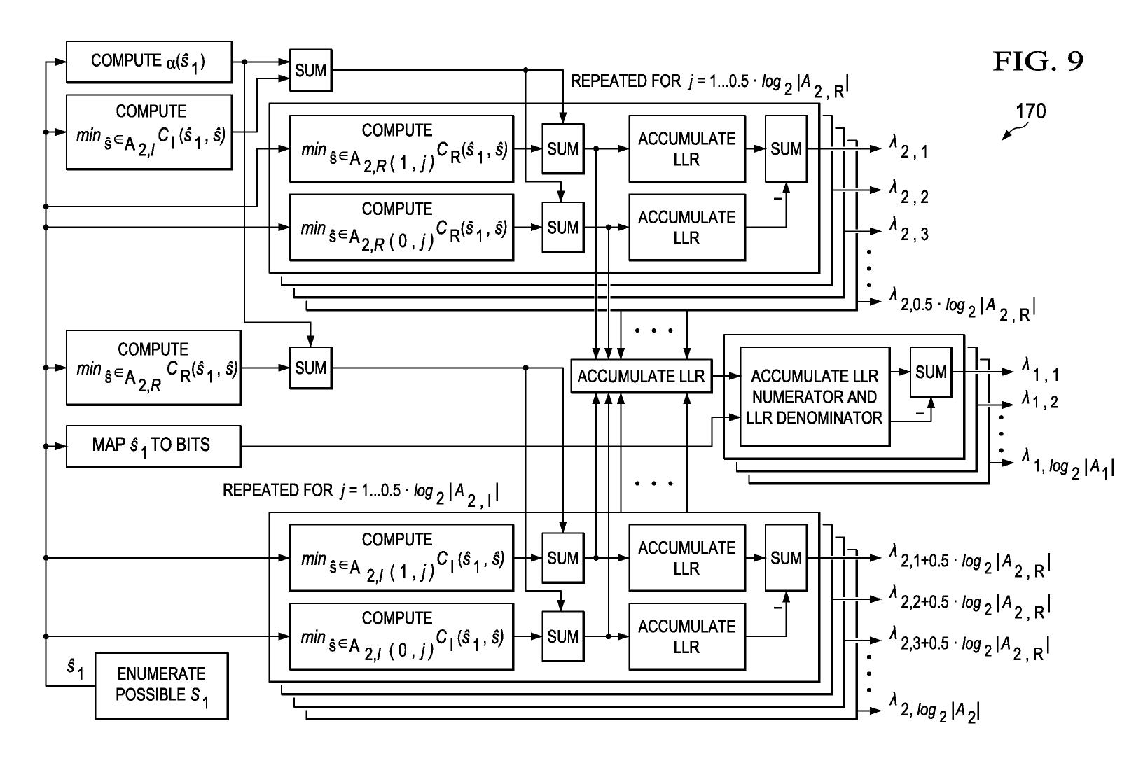

As an example, and not by way of limitation, FIG. 9 illustrates a generalized block diagram of a detector which has been improved by using the teachings of the present disclosure. The original max-log detector was discussed in U.S. patent application Ser. No. 12/062,347, for “Low-Complexity Max-Log MIMO Detector,” incorporated herein. That detector can be modified for improved performance by accumulating the LLR values instead of keeping track of the minimum score for each value of each bit. Specifically, if the Accumulate LLR blocks 250 of the detector of FIG. 9 use the max-log approximation (as in FIG. 4), then the implementation of FIG. 9 is functionally equivalent to the implementation described in U.S. patent application Ser. No. 12/062,347, for “Low-Complexity Max-Log MIMO Detector”. One modification to that detector will enable it to achieve better performance than the max-log detector: namely, change the functionality of LLR accumulators 250 to compute the true LLR instead of the max-log approximation of the LLR. Another example is the detector discussed in U.S. patent application Ser. No. 11/930,259, “Candidate List Generation and Interference Cancellation Framework for MIMO Detector”. One modification to this latter detector enables it to achieve better performance (near-maximum likelihood) than the max-log detector: namely, changing the functionality of LLR accumulators 250 to compute the true LLR instead of the max-log approximation of the LLR.

The MIMO detector implementation described in this section and shown in FIG. 2, can be implemented using any row and column permutations of the channel. In some cases, the column permutation impacts complexity. For example, using the implementation shown in FIG. 9 for a two-input channel, a permutation may be selected to minimize hardware by letting A₁ be the largest alphabet, or instead it may be selected to minimize latency by letting A₂ be the largest alphabet.

Many modifications and other embodiments of the invention will come to mind to one skilled in the art to which this invention pertains having the benefit of the teachings presented in the foregoing descriptions, and the associated drawings. For example, and without limitation, although the present discussion has focused on minimizing the cost, alternatively embodiments of systems and methods can instead maximize the negative of the cost, as described in equation (9). As another example, it is expressly understood that further alternative embodiments may implement tracking the maximum cost, or the two best maximum costs, etc. Therefore, the above discussion is meant to be illustrative of the principles and various embodiments of the disclosure; it is to be understood that the invention is not to be limited to the specific embodiments disclosed. Although specific terms are employed herein, they are used in a generic and descriptive sense only and not for purposes of limitation. It is intended that the following claims be interpreted to embrace all such variations and modifications.

What is claimed is:

1. A communication system, comprising
a detector which computes a set of log-likelihood ratio (LLR) values for a cost function of a channel input by implementing at least one accumulate LLR functional definition.

2. The system of claim 1, wherein the detector is a multiple-input, multiple-output (MIMO) detector.

3. The system of claim 1, wherein the detector implements a max-log approximation.

4. The system of claim 1, further comprising a wireless network.

5. The system of claim 1, wherein the accumulate LLR functional definition uses a hybrid of a recursive structure and a tree structure.

6. The system of claim 1, wherein the accumulate LLR functional definition computes true LLR.

7. The system of claim 1, wherein the accumulate LLR functional definition uses a recursive structure.

8. The system of claim 1, wherein the accumulate LLR functional definition uses a tree structure.

9. The system of claim 1, wherein the cost function is minimized.

10. The system of claim 1, wherein the cost function is maximized.

11. The system of claim 1, wherein the accumulate LLR functional definition computes the LLR using at least two smallest costs.

12. The system of claim 1, wherein the accumulate LLR functional definition computes the LLR using at least two largest costs.

13. The system of claim 1, wherein the detector is a maximum-likelihood detector.

14. A method for communicating, comprising:
computing, using a detector, a set of log-likelihood ratio (LLR) values for a cost function of a channel input by implementing at least one accumulate LLR functional definition.

15. The method of claim 14, wherein the computing further comprises computing using a multiple-input, multiple-output (MIMO) detector.

16. The method of claim 14, wherein the computing further comprises implementing a max-log approximation.

17. The method of claim 14, wherein the computing further comprises computing a set of LLR values for a cost function of a channel input received from a wireless network.

18. The method of claim 14, wherein the computing further comprising using a hybrid of a recursive structure and a tree structure.

19. The method of claim 14, wherein the implementing further comprises computing true LLR.

20. The method of claim 14, wherein the implementing further comprises using a recursive structure.

21. The method of claim 14, wherein the implementing further comprises using a tree structure.

22. The method of claim 14, wherein the implementing further comprises minimizing the cost function.

23. The method of claim 14, wherein the implementing further comprises maximizing the cost function.

24. The method of claim 14, wherein the implementing further comprises computing the LLR using at least two smallest costs.

25. The method of claim 14, wherein the implementing further comprises computing the LLR using at least two largest costs.
